(19) United States
(12) Patent Application Publication
(10) Pub. No.: US 2007/0113969 A1
(43) Pub. Date: May 24, 2007

(54) Optical disk laminating method and optical disk laminating device

(76) Inventors: Ryoko Kitano, Tokushima (JP); Masayuki Tsuruha, Tokushima (JP); Noriyuki Ikeuchi, Tokushima (JP); Yoichi Nakagawa, Tokushima (JP)

Correspondence Address: FLYNN THIEL BOUTELL & TANIS, P.C., 2026 RAMBLING ROAD, KALAMAZOO, MI, 49008-1631, US

(21) Appl. No.: 10/581,590

(22) PCT Filed: Nov. 29, 2004
(86) PCT No.: PCT/JP04/17704

§ 371 Date: Jun. 2, 2006

(30) Foreign Application Priority Data
Dec. 5, 2003 (JP) 2003-408252

(51) Int. Cl. B32B 37/00

(52) U.S. Cl. 156/275.7; 156/307.3; 156/556

(57) ABSTRACT

An optical disk laminating method and an optical disk laminating device capable of shortening tact time is provided. The method comprises the steps of placing lower disks (D2) on chucks installed on a rotating table (1), placing upper disks (D1) over the chucks to be spaced from the lower disks (D2), applying, from the upper side, an adhesive agent to the upper disks (D1) on the chucks, reversing the upper disks (D1) applied with the adhesive agent, applying the adhesive agent to the lower disks (D2), stacking the upper disks (D1) on the lower disks (D2), carrying the stacked disks (D) manufactured in the previous step onto rotating stands (33A) and (33B) by a transfer arm (24) and spreading the adhesive agent, and carrying the stacked disks (D) having the adhesive agent spread on the rotating stands onto an ultraviolet radiating table (34) by the transfer arm (24) and curing the adhesive agent.

### FIELD OF THE INVENTION

The present invention relates to an optical disk laminating method and an optical disk laminating device, and in particular to an optical disk laminating method and an optical disk laminating device capable of shortening tact time.

### BACKGROUND ART

In a manufacturing step of an optical disk such as a DVD-ROM, the work for laminating two sheets of disks to each other is required.

In the laminating work, conventionally, adhesive agent which is ultraviolet-ray cured resin is generally applied on at least a lower disk in a doughnut manner, an upper disk is moved to and placed on the lower disk, and adhesive agent between both the disks is spread uniformly by rotating both the disks at high speed.

The application and the spread of the adhesive agent are generally performed on a rotating stand consistently (see Patent Literature 1).

Specifically, such a process is performed that a lower disk is put on a rotating stand, the rotating stand is rotated at low speed, adhesive agent is applied from a dispenser in a doughnut manner, an upper disk is put on the lower disk, the rotating stand is then rotated at high speed, and adhesive agent between both the disks is spread.

However, when a stacking operation for the upper and lower disks is made excessively fast, such a problem arises that bubbles easily enter in the adhesive agent between both the disks.

Further, there is such a problem that some time period is required for removing bubbles from between the disks utilizing a centrifugal force by the spreading, and the time period is not can not be shortened easily.

Therefore, the stacking work is performed on the rotating stand consistently, which results in relative extension of tact time from transfer of the lower disk to the rotating stand to taking-out of both the disks through the termination of the application and spread of the adhesive agent.

Further, a laminating method where not only a lower disk but also an upper disk is applied with adhesive agent has been known (see Patent Literature 2). However, even if this method is used, such a problem can not be solved completely that bubbles easily enter in the adhesive agent between upper and lower disks like the above.

Similarly to the method described in Patent Literature 1, there is such a problem that some spreading time period is required for removing bubbles which have entered in the adhesive agent and the time period can not be shortened easily.

In order to solve the above problem, there is also such a method that the number of rotating stands is increased so that rapidness of the tact time is achieved.

However, a board space must be secured for increasing the number of rotating stands so as to meet a demand for further shortening of the tact time, which goes against a demand for space saving.

The present inventors has already filed a patent application disclosing an optical disk laminating method constituted such that generation of bubbles in a gap between the upper disk and the lower disk can be suppressed as much as possible in a series of flows for manufacturing an optical disk (see Patent Literature 3).

The method satisfies a demand for shortening tact time and compactness of a device to some extent.

FIG. 12 shows an outline of the conventional optical disk laminating device, FIG. 12(A) being a plan view of the optical disk laminating device and FIG. 12(B) being a side view thereof along line A-B-C-D in FIG. 12(A).

In a method using the optical disk laminating device, an upper disk D1 is moved and placed to a position a of a rotating table 100 by a transfer unit 101 and a lower disk D2 is moved and placed to a position b by a transfer unit 102 from a stoker or a manufacturing line.

The rotating table 100 is intermittently rotated (in a counterclockwise direction in FIG. 12(A)) so that the upper disk D1 at the position a is moved to a position c and the lower disk D2 at the position b is moved to a position d, respectively.

After being applied with adhesive agent in a doughnut manner from a dispenser 103 at the position c, the upper disk D1 is fed to a position e, where the disk D1 is reversed by a revering unit 104, and the upper disk D1 is fed to a position

The lower disk D2 is fed from the position b to a position f via the position d, it is applied from the dispenser 105 with adhesive agent in a doughnut manner, and it is fed to a position h.

Next, in this state, the upper disk D1 at the position g is held by a suction chuck 200b (described in FIG. 12(B)) of an arm portion 200a1 of a transfer arm 200 to be lifted up from the position g and it is conveyed above the lower disk D2 at the position h.

Then, the transfer arm 200 descends in a certain distance and an arm portion 200a2 holds the stacked disks D which has been subjected to spreading on a rotating stand 300.

In this state, the lower disk D2 placed at the position h is lifted up calmly by an ascending and descending unit 106 (described in FIG. 12(B)) and it is laminated to the upper disk D1 held by the suction chuck 200b.

Next, the transfer arm 200 is pivoted so that stacked disks D just laminated are conveyed from the position h to the rotating stand 300.

Simultaneously, the stacked disks D which have been subjected to the spreading on the rotating stand 300 is conveyed to an ultraviolet irradiating table 400 by the arm portion 200a2.

Simultaneously with pivoting of the transfer arm 200, the rotating table 100 is intermittently rotated, so that the upper disk D1 at the position e is moved to a position g and the lower disk D2 at the position f is moved to the position h, respectively.

The arm portions 200a1 and 200a2 of the transfer arm 200 which have released the stacked disks D respectively pivots in a reverse direction (counterclockwise direction in FIG. 12(A)) and the arm portion 200a2 lifts up an upper disk D1 from the position g to convey the same to the position h.

Simultaneously, the arm portion 200a1 holds stacked disks D which have been subjected to spreading on a rotating stand 301.

Then, simultaneously with conveyance of the stacked disks D from the position h to the rotating stand 301 performed by the arm portion 200a2, the arm portion 200a1 conveys the stacked disks D which have been subjected to spreading on the rotating stand 301 to an ultraviolet irradiating table 400.

Like the optical disk laminating method, by separating the stacking work conventionally performed on the rotating stand consistently to the application of adhesive agent performed in a disk supplying step and the spreading of the adhesive agent performed on the rotating stand, the tact time can be shortened to some extent.

Patent Literature 1: JP-A-11-345433

Patent Literature 2: JP-A-2002-312983

Patent Literature 3: Japanese Patent Application No. 2003-330687

### DESCRIPTION OF THE INVENTION

In the optical disk laminating method described in Patent Literature 3, however, such a case frequently occurs that, while one member is performing the work, the other member must stop its working to be put in a standby state or the like, and the work can not be efficiently performed necessarily, which can not be said to satisfy the demand for tact time shortening.

Further, since the angle between the arm portion 200a1 and the arm portion 200a2 is fixed, there is such a problem that only two rotating stands can be provided ordinarily.

For example, even if the number of the rotating stands to be provided is increased to four in order to shorten the tact time, since the behavior of the transfer arm 200 is further complicated, there is such a problem that it is impossible to shorten the tact time as expected in fact.

The present invention has been made in view of such a background, and it has been made for overcoming the problems in the above-described conventional art.

That is, an object of the present invention is to provide an optical disk laminating method and an optical disk laminating device which can shorten tact time.

### MEANS FOR SOLVING THE PROBLEM

The invention described in claim 1 lies in an optical disk laminating method for laminating an upper disk and a lower disk via adhesive agent, comprising: a lower disk supplying step of conveying a lower disk above a rotating table by a lower disk supplying unit and placing the lower disk on a plurality of upper and lower disks placing jigs provided along a circumferential direction of a base plate placing portion on the rotating table; an upper disk supplying step of conveying an upper disk above the rotating table by an upper disk supplying unit and placing the upper disk on the upper and lower disks placing jigs on which the lower disk is placed so as to be spaced from the lower disk; an adhesive agent applying step for an upper disk of applying adhesive agent on the upper disk from the above in a state that the upper disk and the lower disk have been placed on the upper and lower disks placing jigs; an upper disk reversing step of reversing the upper disk applied with the adhesive agent; an adhesive agent applying step for a lower disk of applying adhesive agent to the lower disk after the upper disk reversing step; a disk stacking step of stacking the upper disk and the lower disk after the adhesive agent applying step for a lower disk; an adhesive agent spreading step of, after conveying the stacked disks manufactured in the disk stacking step to a rotating stand for spreading adhesive agent by a transfer arm, spreading the adhesive agent applied to the stacked disks on the rotating stand; and a light ray irradiating step of, after conveying the stacked disks where the adhesive agent has been spread on the rotating stand to a light ray irradiating table by the transfer arm, curing the adhesive agent.

The invention described in claim 2 lies in an optical disk laminating method for laminating an upper disk and a lower disk via adhesive agent, comprising: a lower disk supplying step of conveying a lower disk above a rotating table by a lower disk supplying unit and placing the lower disk on a plurality of upper and lower disks placing jigs provided along a circumferential direction of a base plate placing portion on the rotating table; an upper disk supplying step of conveying an upper disk above the rotating table by an upper disk supplying unit and placing the upper disk on the upper and lower disks placing jigs on which the lower disk is placed so as to be spaced from the lower disk; an adhesive agent applying step of, after a nozzle is inserted between the upper disk and the lower disk that have been placed on upper and lower disks placing jigs, applying adhesive agent from the nozzle on at least one of a lower face of the upper disk and an upper face of the lower disk; a disk stacking step of stacking the upper disk and the lower disk after the adhesive agent applying step; an adhesive agent spreading step of, after conveying the stacked disks manufactured in the disk stacking step to a rotating stand for spreading adhesive agent by a transfer arm, spreading the adhesive agent applied to the stacked disks on the rotating stand; and a light ray irradiating step of, after conveying the stacked disks where the adhesive agent has been spread on the rotating stand to a light ray irradiating table by the transfer arm, curing the adhesive agent.

The invention described in claim 3 is an optical disk laminating device comprising; a lower disk supplying unit for placing a lower disk on a rotating table; an upper disk supplying unit for placing an upper disk on the rotating table, which is provided on a downstream step side of the lower disk supplying unit; an adhesive agent applying unit for an upper disk which is provided on a downstream side of the upper disk supplying unit, for applying adhesive agent on the upper disk from the above; a reversing unit which is provided on a downstream step side of the adhesive agent applying unit for an upper disk, for reversing the upper disk applied with the adhesive agent; an adhesive agent applying unit for a lower disk which is provided on a downstream step side of the reversing unit, for applying adhesive agent to the lower disk from the above; a suction unit for lifting up the lower disk, while sucking the same, and laminating the lower disk with the upper disk; and a stacked disks transferring device which has a sucking portion which sucks and holds the upper disk when the upper disk and the lower disk are laminated, conveying the stacked disks from the rotating table to a rotating stand for spreading adhesive agent, and conveying the stacked disks where the adhesive agent has been spread on the rotating stand to a light ray irradiating table, wherein an upper and lower disks placing jigs on which the upper disk and the lower disk can be placed with a space in a vertical direction are provided around a disk placing portion on the. rotating table.

The invention described in claim 4 is an optical disk laminating device comprising; a lower disk supplying unit for placing a lower disk on a rotating table; an upper disk supplying unit which is provided on a downstream step side of the lower disk supplying unit, for placing an upper disk on the rotating table; an adhesive agent applying unit which is provided on a downstream step side of the upper disk supplying unit, for applying adhesive agent from the nozzle inserted between the upper disk and the lower disk on at least one of a lower face of the upper disk and an upper face of the lower disk; a suction unit for lifting up the lower disk while sucking the same and laminating the lower disk with the upper disk; and a stacked disks transferring device which has a suction portion for sucking and holding the upper disk when the upper disk and the lower disk are laminated to each other, conveying the stacked disks from the rotating table to a rotating stand for spreading adhesive agent, and conveying the stacked disks where the adhesive agent has been spread on the rotating stand to a light ray irradiating table, wherein an upper and lower disks placing jigs on which the upper disk and the lower disk can be placed with a space in a vertical direction are provided around a disk placing portion on the rotating table.

The invention described in claim 5 lies in such a constitution of the optical disk laminating device according to claim 3 or claim 4 that the upper and lower disks placing jig comprises an upper disk placing portion and a lower disk placing portion, and the upper disk placing portion is movable between a position where the lower disk can be inserted up to the lower disk placing portion and a position where the lower disk is placed.

Incidentally, any constitution obtained by combining the above claims properly can be adopted as long as it satisfies the object of the present invention.

### EFFECT OF THE INVENTION

According to the present invention, an upper disk is placed on an upper and lower disks placing jig with a space after a lower disk is placed on the upper and lower disks placing jig.

Therefore, since it is not necessary to place an upper disk and a lower disk at different positions on the rotating table like the conventional art, the steps of performing stacking of an upper disk and a lower disk can be reduced, so that shortening of tact time can be achieved.

By inserting a nozzle for applying adhesive agent between the upper disk and the lower disk and applying adhesive agent on at least one of the upper disk and the lower disk without reversing the upper and lower disks, steps in disks stacking can be reduced to a great extent, so that tact time can be greatly shortened.

### BEST MODE FOR CARRYING-OUT OF THE INVENTION

Best mode for carrying out the present invention will be explained below with reference to the drawings.

### FIRST EMBODIMENT

FIG. 1 shows an optical disk laminating device according to a first embodiment of the present invention.

In the optical disk laminating device according to the first embodiment, an upper disk D1 and a lower disk D2 are supplied on a rotating table 1 from a stocking device or an upstream process line, where such steps as applying of adhesive agent, reversing of the upper disk D1, and stacking of both the disks D1 and D2 are sequentially performed.

The upper disk D1 and the lower disk D2 stacked with each other are spread with adhesive agent by rotating stands 33A and 33B, and the stacked disks are then transferred to an ultraviolet irradiating table 34 to be irradiated with ultraviolet for curing the adhesive agent.

The laminating method will be explained below with reference to a flowchart shown in FIG. 2 in the order of steps.

First, in step S11, as shown in FIG. 1, the lower disk D2 is supplied from a stocking device or a manufacturing line to a position a on the rotating table 1 by a transfer arm 2 which is a lower disk supplying unit.

Here, operation of ancillary equipment performed when the lower disk D2 is supplied to the position a will be explained with reference to FIG. 3.

Chucks 3 which are upper and lower disks placing jigs are respectively provided at three portions around a portion on which the lower disk D2 is placed at intervals of an angle of 120° about the central axis of the portion.

FIG. 3 shows a state of the chucks 3 just before they are opened.

A chuck holding device 4 which can ascend and descend is provided at a lower end side of the chucks 3.

The chuck holding device 4 comprises a cylindrical cylinder portion 5 and a three-direction cam arm 6 for holding the chucks 3.

Ω-shaped notched portions la are formed at positions where a disk is placed on the rotating table 1 such that a suction unit 21 described later is capable of passing through each Ω-shaped notched portion 1a.

Opening and closing operations of each chuck 3 will be explained below with reference to FIG. 4.

As shown in FIG. 4(A), the chuck 3 has a lower disk placing portion 7 which is placed on the rotating table and an upper disk placing portion 9 which is connected to the lower disk placing portion 7 via a pivoting shaft 8.

A spring 10 is compressed and interposed between the upper disk placing portion 9 and the lower disk placing portion 7 at a lower side of the pivoting shaft 8.

The upper disk placing portion 9 is a rod-like member, and its upper end is bent in an L shape on which the upper disk D1 can be placed, so that the upper disk D is placed on a distal end of the bent portion 9a.

On the other hand, a lower end of the upper disk placing portion 9 is also bent in an L shape, and a roller 11 (so called “follower”) is attached to a distal end of the bent portion 9b.

The three-direction cam arm 6 is disposed below the rotating table 1, and the three-direction cam arm 6 ascends when the lower disk D2 is supplied to the position a.

When the three-direction cam arm 6 ascends and a taper portion 6a of the three-direction cam arm 6 abuts on the roller 11, such a state as shown in FIG. 4(B) is obtained.

When the three-direction cam arm 6 ascends higher, the roller 11 rotates in a clockwise direction and it runs on an upper surface of the taper portion 6a, as shown in FIG. 4(C).

Since the bent portion 9a of the upper disk placing portion 9 pivots about the pivoting shaft 8 to be opened outwardly, the lower disk D2 descends with no obstruction to be placed on the lower disk placing portion 7.

Next, the rotating table 1 is intermittently rotated, so that the control proceeds to step S12.

In step S12, the upper disk D1 is supplied to a position b above the lower disk D2 with a predetermined space by a transfer arm 12 which is an upper disk supplying unit.

At that time, the upper disk D1 is placed on the bent portions 9a described in FIG. 3.

Next, the rotating table 1 is intermittently rotated, so that the control proceeds to step S13.

In step S13, ultraviolet cure adhesive agent is applied to the upper disk D1 by a dispenser 13 which is an adhesive agent applying unit for an upper disk at a position c.

Then, the rotating table 1 is intermittently rotated, so that the control proceeds to step S14.

In step S14, the upper disk D1 applied with the adhesive agent is reversed by a reversing unit 14 at a position d Here, operation performed when the upper disk D1 is reversed will be explained with reference to FIG. 5 and FIG. 6.

FIG. 5(A) shows such a state that the upper disk D1 is held by the reversing unit 14, which is viewed from above.

The reversing unit 14 includes a pair of thin plate-like arc shape clamp portions 15, and claw portions 15a are respectively provided at two portions of each respective clamp portion 15.

FIG. 5(B) is a sectional view of the reversing unit taken along line A-B-C in FIG. 5(A).

As shown in FIG. 5(B), the upper disk D1 is clamped in a trapezoidal groove defined by the respective claw portions 15a to be held.

FIG. 6 shows such a state that the upper disk D1 has been lifted up from the chucks 3 while being clamped by the claw portions 15a of the clamp portions 15.

A base portion 16 of the reversing unit 14 is fixed to a base stand (not shown) via an L-shaped metal part 17 by bolts.

A moving plate 18 which can be ascended and descended by a vertical moving unit (not shown) is provided on a side face of the base portion 16, and a cylindrical rotational portion 19 is attached to an upper end of the moving platel8.

The plate-like clamp portions 15 are reversed according to rotating of the rotational portion 19 by an angle of 180°, so that the upper disk D1 is also reversed.

As a result, the surface of the upper disk D1 applied with the adhesive agent positions to face downward.

Then, the moving plate 18 is descended and the upper disk D1 is placed on the upper disk placing portions 9 of the chucks 3 again.

Then, the rotating table 1 is intermittently rotated, so that the control proceeds to step S15.

In step S15, ultraviolet cure adhesive agent is applied to the lower disk D2 by a dispenser 20 which is an adhesive agent applying unit for a lower disk at a position e.

Then, the rotating table 1 is intermittently rotated, so that the control proceeds to step S16.

In step S16, the lower disk D2 is lifted up, the upper disk D1 and the lower disk D2 are stacked with each other at a position f.

Here, operation performed when the upper disk D1 and the lower disk D2 are stacked with each other will be explained with reference to FIG. 7 and FIG. 8.

As shown in FIG. 7, a chuck holding device 22 having a suction unit 21 having a disk-shaped member on which a plurality of ventilation holes are formed is provided below the rotating table 1 so as to be capable of ascending and descending.

A three-direction cam arm 23 for opening and closing the chucks 3 erectly is provided on the chuck holding device 22.

On the other hand, the upper disk D1 is sucked with vacuum by a suction portion 25 attached to a distal end of a transfer arm 24.

FIG. 8 shows a state that the chuck holding device 22 has ascended.

FIG. 8(A) shows a state that the taper portion 23b formed on an erected portion 23a of the three-direction cam arm 23 has abutted on the roller 11 so that the upper disk placing portion 9 has pivoted.

At that time, though the upper disk D1 is spaced from the upper disk placing portion 9, the upper disk D1 is staying in the air while being holding by the suction portion 25.

On the other hand, the lower disk D2 is out of contact with the suction unit 21, and it is put in a state that it has been placed on the lower disk placing portion 7.

Next, when the chuck holding device 22 is further ascended, such a state as shown in FIG. 8(B) is obtained.

At that time, a distal end of the erected portion 23a of the three-direction cam arm 23 is projected above a through hole 1b formed on the rotating table 1.

The lower disk D2 is placed on the suction unit while being sucked by the suction unit 21, and it is put in a state that the lower disk D2 together with the suction unit 21 is close to the upper disk D1.

When the lower disk D2 is further ascended, adhesive agents 26 of both the disks D1 and D2 come in contact with each other, so that the upper disk Dl and the lower disk D2 come in close contact with each other.

FIG. 9 shows details of the suction portion 25 described in FIG. 8.

The suction portion 25 has a pickup head 27 which is constituted so as to be capable of sucking and holding the upper disk D1.

The pickup head 27 sucks and holds the upper disk D1 while the surface of the upper disk D1 applied with the adhesive agent faces downward.

The pickup head 27 is attached to the transfer arm 24, so that the pick up head 27 together with the transfer arm 24 can be ascended and descended.

A plurality of pads 28 are provided at intervals on a lower face of the pickup head 27 along a circumferential direction viewed from above.

The upper disk D1 is sucked using negative pressure via a vacuum path 29 and is held by the pads 28.

The pickup head 27 is formed with a supporting face 27a coming in contact with a central region of the upper disk D1 in a planar manner, so that the central region of the upper disk D1 can be positioned and held in a planar manner by the supporting face 27a of the pick up head 27.

Since the central region of the upper disk D1 is thus supported in a planar manner, the upper disk itself is made flat as a whole.

In the central portion of the pickup head 27, chuck claws 30 engaging an inner peripheral edge of the center hole of the upper disk D1 is suspended, the chuck claws 30 are opened and closed by the driving portion 31.

Both the disks D1 and D2 are temporally caught by opening of the chuck claw 30.

Then, the control proceeds to step S17.

In step S17, as shown in FIG. 1, the stacked disks D are conveyed from the position f on the rotating table 1 to the rotating stand 33A or the rotating stand 33B by the transfer arm 24 provided on the stacked disks transferring device 32.

The stacked disks D conveyed to the rotating stand 33A or 33B are rotated at high speed, so that the adhesive agent between the upper disk D1 and the lower disk D2 is spread.

Then, the control proceeds to step S18.

In step S18, the stacked disks D rotated at high speed on the rotating stand 33A or the rotating stand 33B are conveyed to the ultraviolet irradiating table 34 by the transfer arm 24 provided on the stacked disks transferring device 32.

Ultraviolet is irradiated to the stacked disks D placed on the ultraviolet irradiating table, so that the adhesive agent is cured, and lamination of both the disks D1 and D2 is terminated.

In the optical disk laminating device according to the first embodiment described above, after the lower disk D2 is placed on the chucks 3, the upper disk D1 is placed on the chucks 3 with a space between the upper disk D1 and the lower disk D2.

Therefore, since it is not necessary to place the upper disk D1 and the lower disk D2 at different positions on the rotating table like the conventional art, the steps for performing stacking of disks can be reduced, so that shortening of tact time can be achieved.

Eight sheets of disks are placed on the conventional rotating table 100, but, only six sheets of disks are placed on the rotating table 1 in the first embodiment. Therefore, the size of the rotating table 1 can be reduced, so that space saving for device installation space can be achieved.

### SECOND EMBODIMENT

FIG. 10 shows an optical disk laminating device according to a second embodiment of the present invention.

In the optical disk laminating device according to the second embodiment, an upper disk D1 and a lower disk D2 are supplied on a rotating table 1A from a stocking device or an upstream process line, and such steps as applying of adhesive agent and stacking of both the disks D1 and D2 are sequentially performed on the rotating table.

The upper disk D1 and the lower disk D2 stacked with each other are spread with adhesive agent by a rotating stand 33A or 33B, and the stacked disks are then transferred to an ultraviolet irradiating table 34 to be irradiated with ultraviolet for curing the adhesive agent.

An optical disk laminating method will be explained below with reference to a flowchart shown in FIG. 11 in the order of steps.

In step S21, as shown in FIG. 10, a lower disk D2 is first supplied from the stocking device or a manufacturing line to a position a on the rotating table 1A by the transfer arm 2.

Then, the rotating table 1A is intermittently rotated so that the control proceeds to step S22.

In step S22, as shown in FIG. 10, an upper disk D1 is supplied to a position b above the lower disk D2 with a predetermined space by a transfer arm 12.

At that time, the upper disk D1 is placed on the bent portions 9a of the upper disk placing portion 9 described in FIG. 3.

Next, the rotating table 1A is intermittently rotated so that the control proceeds to step S23.

In step S23, as shown in FIG. 10, a nozzle of a dispenser 13 is inserted between the upper disk D1 and the lower disk D2 at a position c, and adhesive agent is applied to the lower disk D2.

At that time, it is better to apply adhesive agent to the upper disk D1, but, when a space between the upper disk D1 and the lower disk D2 is small, it is actually difficult to apply adhesive agent to both the faces of the upper disk D1 and the lower disk D2. In such a case, therefore, it is prefer to apply adhesive agent to only the lower disk D2.

Then, the rotating table 1A is intermittently rotated so that the control proceeds to step S24.

In step S24, at a position d shown in FIG. 10, the lower disk D2 is lifted up by the same method as shown in FIG. 8 described above, and the upper disk D1 and the lower disk D2 are stacked with each other.

Then, the control proceeds to step S25.

In step S25, as shown in FIG. 10, the stacked disks D are conveyed from the position d on the rotating table 1A to the rotating stand 33A or the rotating stand 33B by the transfer arm 24 provided on the stacked disks transferring device 32.

The stacked disks D conveyed to the rotating stand 33A or 33B are rotated at high speed, so that the adhesive agent between the upper disk D1 and the lower disk D2 is spread.

Then, the control proceeds to step S26.

In step S26, the stacked disks D rotated at high speed on the rotating stand 33A or the rotating stand 33B are conveyed to the ultraviolet irradiating table 34 by the transfer arm 24 provided on the stacked disks transferring device 32. Ultraviolet is irradiated to the stacked disks D placed on the ultraviolet irradiating table, so that the adhesive agent is cured and lamination of both the disks D1 and D2 is terminated.

In the optical disk laminating device according to the second embodiment described above, by inserting the nozzle for applying adhesive agent between the upper disk D1 and the lower disk D2 and applying adhesive agent on at least one of the upper disk D1 and the lower disk D2 without reversing the upper and lower disks, steps of disks stacking can be reduced to a great extent, so that tact time can be greatly shortened.

Eight sheets of disks are placed on the conventional rotating table 100, but only four sheets of disks are placed on the rotating table 1A in the second embodiment. Therefore, the size of the rotating table 1 can be reduced, so that space saving for device installation space can be achieved.

The present invention has been explained above, but the present invention is not limited to only the first and second embodiments described above, and various changes can be performed without departing from the gist of the present invention.

For example, in the first embodiment described above, the example that adhesive agent is applied to the upper disk D1 and the lower disk D2 respectively has been explained, but it is possible to apply adhesive agent only to one disk, for example, only to the lower disk D2.

As the upper and lower disks placing jig, the chuck 3 having the upper disk placing portion 9 and the lower disk placing portion 7 has been explained as an example, but the upper and lower disks placing jig of the present invention is not limited to the example.

For example, the upper and lower disks placing jig can be constituted from one member.

This is because, when the upper and lower disks placing jig is rotated, the upper disk placing portion positioned at the upper end side of the upper and lower disks placing jig pivots more largely than the lower disk placing portion thereof.

### INDUSTRIAL APPLICABILITY

The present invention relates to an optical disk laminating method and an optical disk laminating device, but the present invention can be applied to a disk-shaped recording medium, of course, so that tact time can be reduced in the whole method and device.

### BRIEF DESCRIPTION OF THE DRAWINGS

FIG. 1 is an explanatory view showing a first embodiment of an optical disk laminating device of the present invention.

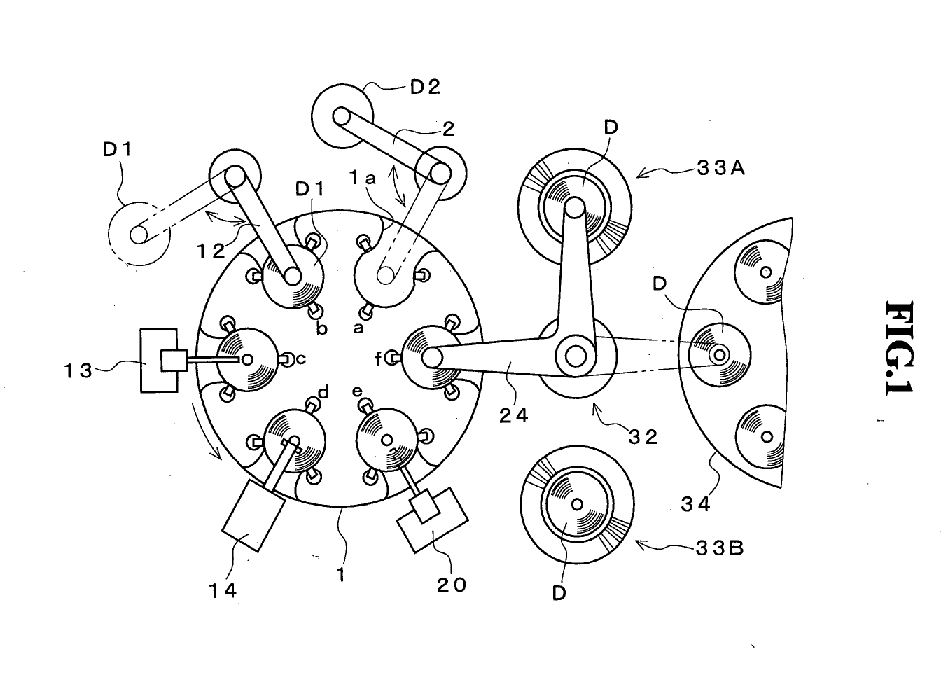

FIG. 2 is an explanatory view showing a processing flow in the optical disk laminating device in FIG. 1.

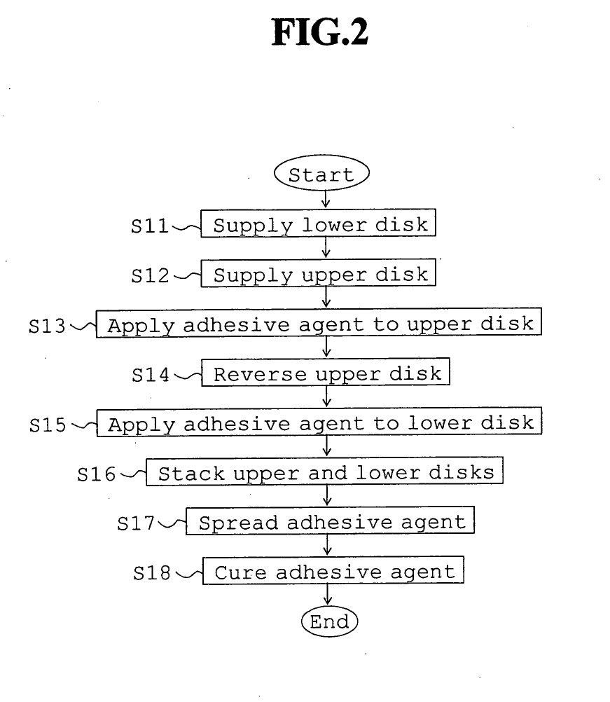

FIG. 3 is an explanatory view showing a state that a lower disk is supplied at a position a in FIG. 1.

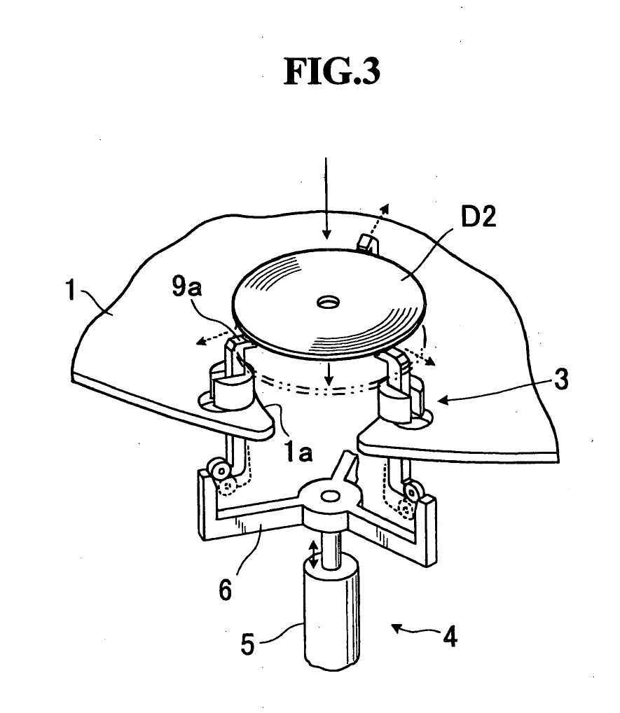

FIG. 4 is an explanatory view showing details of a chuck in FIG. 3. FIG. 4(A) shows a state that a three-direction cam arm approaches to the chuck. FIG. 4(B) shows a moment at which the three-direction cam arm abuts on a roller provided on the chuck. FIG. 4(C) shows a state that an upper disk placing portion is opened by the three-direction cam arm.

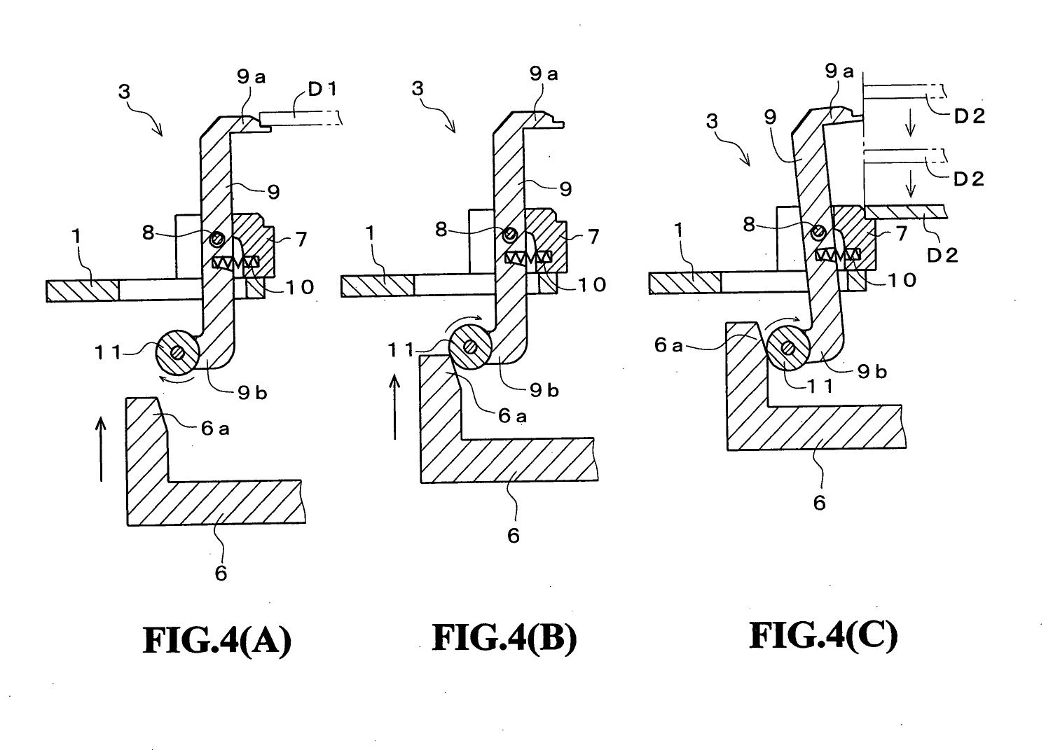

FIG. 5 shows a state that an upper disk placed on the upper disk placing portion is clamped by clamp portions. FIG. 5(A) is a plan view and FIG. 5(B) is a sectional view taken along line A-B-C in FIG. 5(A).

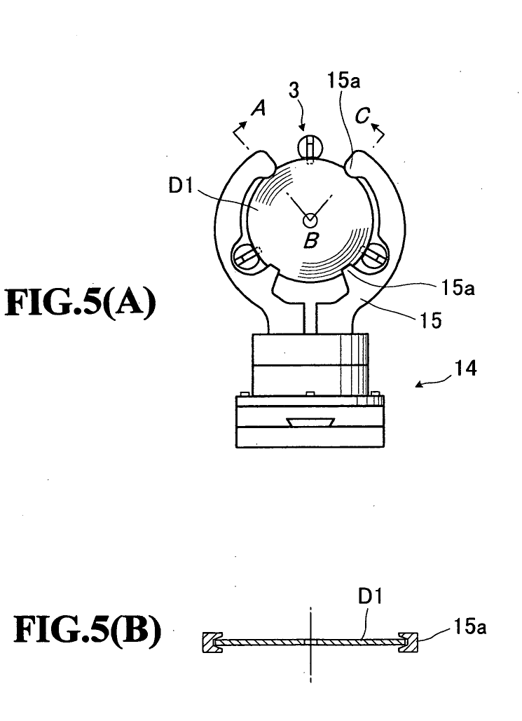

FIG. 6 shows a state that the upper disk is reversed while being clamped by the clamp portions.

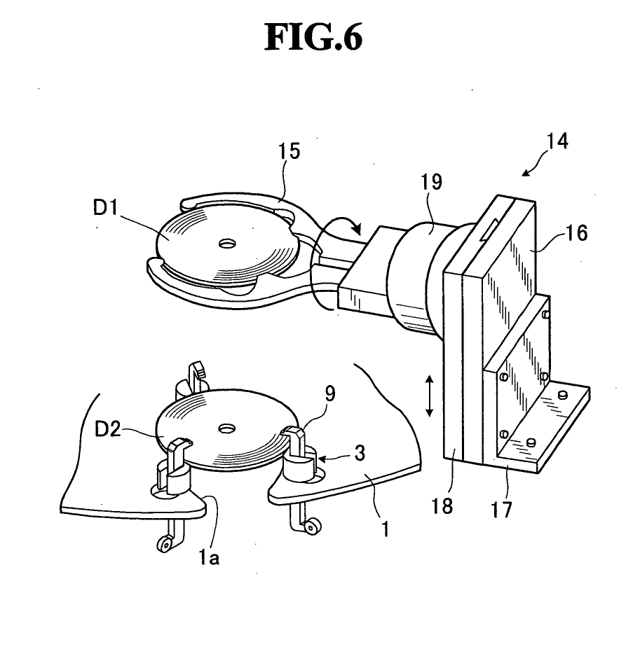

FIG. 7 is an explanatory view showing a state that the upper disk and the lower disk are stacked with each other.

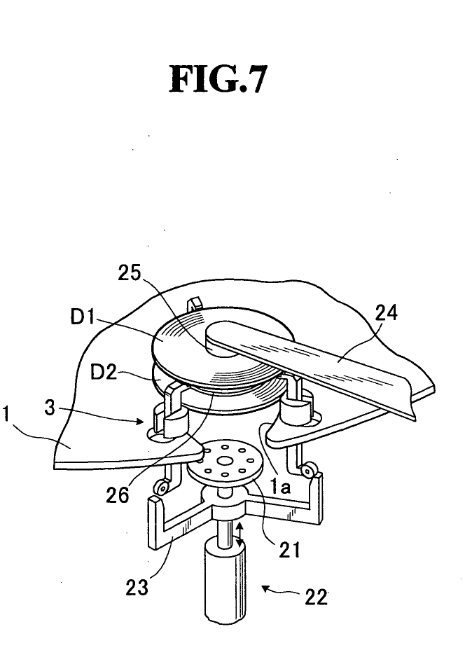

FIG. 8 is an explanatory view showing operations of peripheral devices when the upper disk and the lower disk are stacked with each other. FIG. 8(A) shows a state before a suction unit abuts on the lower disk. FIG. 8(B) shows a state that the lower disk is close to the upper disk while being held by the suction unit.

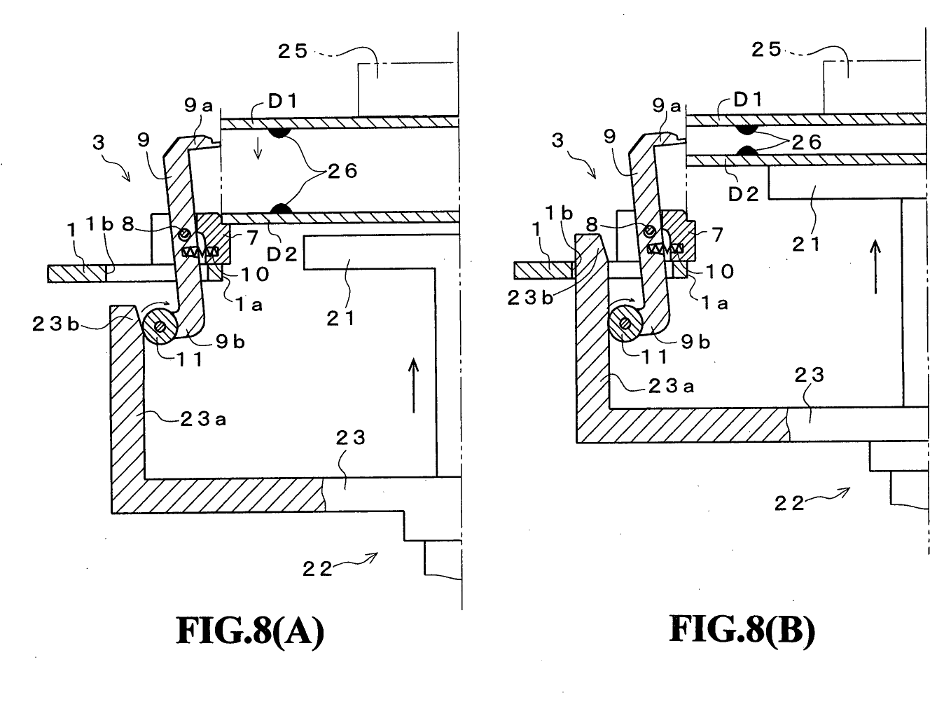

FIG. 9 is an explanatory view showing details of a suction portion in FIG. 8.

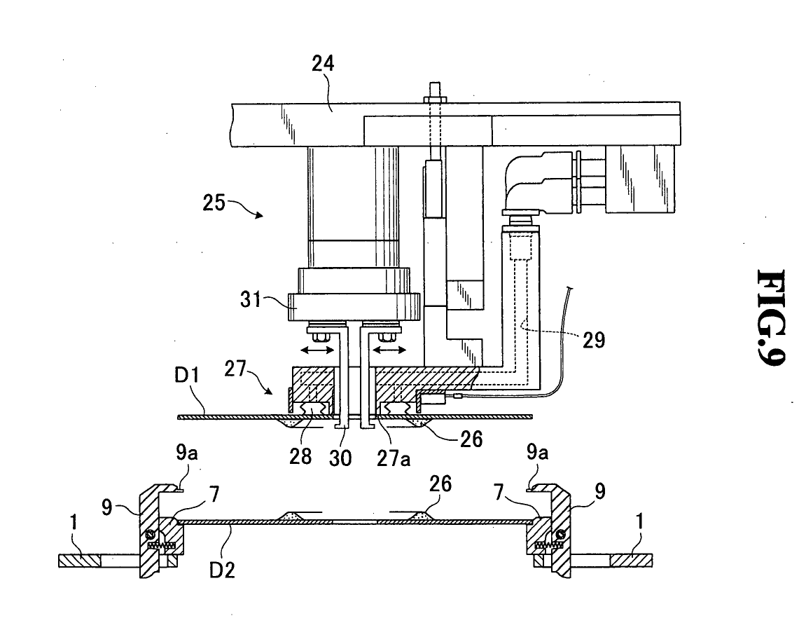

FIG. 10 is an explanatory view showing a second embodiment of the optical disk laminating device of the present invention.

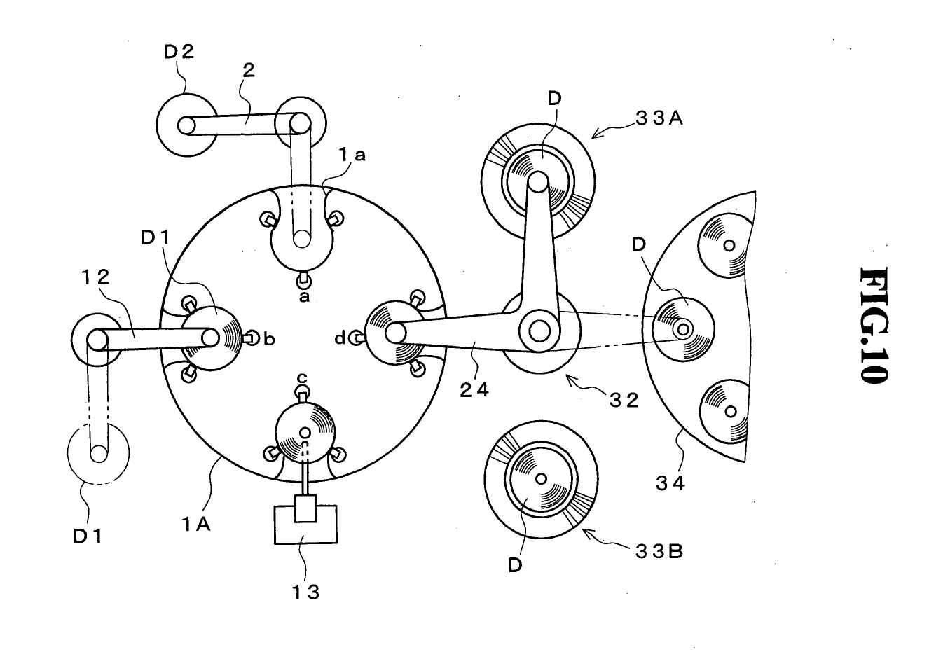

FIG. 11 is an explanatory view showing a processing flow in the optical disk laminating device in FIG. 10.

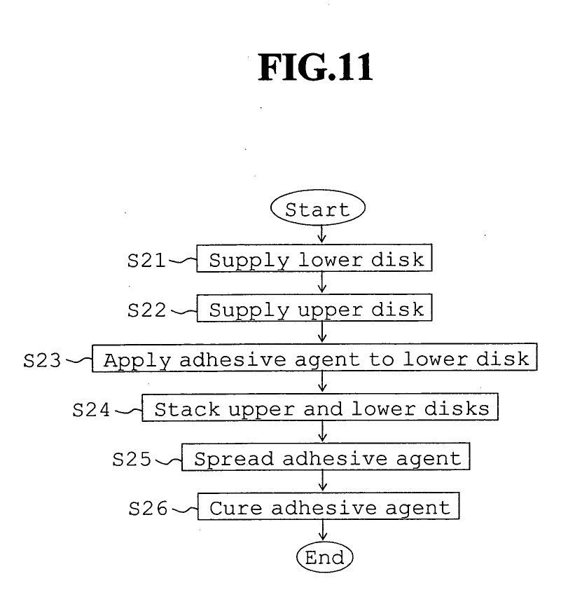

FIG. 12 is an explanatory view showing a conventional optical disk laminating device. FIG. 12(A) is a plan view and FIG. 12(B) is a sectional view taken along line A-B-C-D in FIG. 12(A).

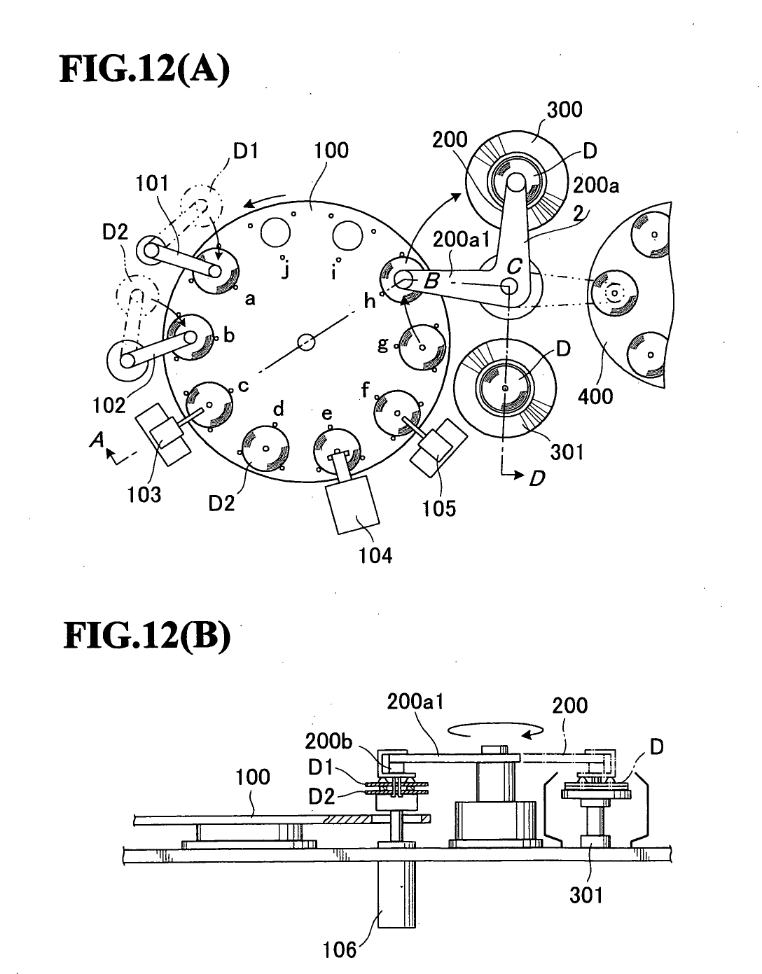

### EXPLANATION OF REFERENCE NUMERALS

1, 1A: rotating table
1a: notched portion
1b: through hole
2: transfer arm
3: chuck
4: chuck holding device
5: cylinder portion
6: three-direction cam arm
6a: taper portion
7: lower disk placing portion
8: pivoting shaft
9: upper disk placing portion
9a, 9b: bent portion
10: spring
11: roller
12: transfer arm
13: dispenser
14: reversing unit
15: clamp portion
15a: claw portion
16: base portion
17: L-shape metal part
18: moving plate
19: rotational portion
20: dispenser
21: suction unit
22: chuck holding device
23: three-direction cam arm
23a: erected portion
23b: taper portion
24: transfer arm
25: suction portion
26: adhesive agent
27: pickup head
27a: support face
28: pad
29: vacuum path
30: chuck claw
31: driving portion
32: stacked disks transferring device
33A, 33B: rotating stand
34: ultraviolet irradiating table
100: rotating table
101, 102: transferring unit
103, 105: dispenser
104: reversing unit
106: ascending and descending unit
200: transfer arm
200a1, 200a2: arm portion
200b: suction chuck
300, 301: rotating stand
400: ultraviolet irradiating table
D: stacked disks
D1: upper disk
D2: lower disk
a to 1: position

1. An optical disk laminating method for laminating an upper disk and a lower disk via adhesive agent, comprising:
a lower disk supplying step of conveying a lower disk above a rotating table by a lower disk supplying unit and placing the lower disk on a plurality of upper and lower disks placing jigs provided along a circumferential direction of a base plate placing portion on the rotating table;
an upper disk supplying step of conveying an upper disk above the rotating table by an upper disk supplying unit and placing the upper disk on the upper and lower disks placing jigs on which the lower disk is placed so as to be spaced from the lower disk;
an adhesive agent applying step for an upper disk of applying adhesive agent on the upper disk from the above in a state that the upper disk and the lower disk have been placed on the upper and lower disks placing jigs;
an upper disk reversing step of reversing the upper disk applied with the adhesive agent;
an adhesive agent applying step for a lower disk of applying adhesive agent to the lower disk after the upper disk reversing step;
a disk stacking step of stacking the upper disk and the lower disk after the adhesive agent applying step for a lower disk;
an adhesive agent spreading step of, after conveying the stacked disks manufactured in the disk stacking step to a rotating stand for spreading adhesive agent by a transfer arm, spreading the adhesive agent applied to the stacked disks on the rotating stand; and
a light ray irradiating step of, after conveying the stacked disks where the adhesive agent has been spread on the rotating stand to a light ray irradiating table by the transfer arm, curing the adhesive agent.

2. An optical disk laminating method for laminating an upper disk and a lower disk via adhesive agent, comprising:
a lower disk supplying step of conveying a lower disk above a rotating table by a lower disk supplying unit and placing the lower disk on a plurality of upper and lower disks placing jigs provided along a circumferential direction of a base plate placing portion on the rotating table;
an upper disk supplying step of conveying an upper disk above the rotating table by an upper disk supplying unit and placing the upper disk on the upper and lower disks placing jigs on which the lower disk is placed so as to be spaced from the lower disk;
an adhesive agent applying step of, after a nozzle is inserted between the upper disk and the lower disk that have been placed on upper and lower disks placing jigs, applying adhesive agent from the nozzle on at least one of a lower face of the upper disk and an upper face of the lower disk;
a disk stacking step of stacking the upper disk and the lower disk after the adhesive agent applying step;
an adhesive agent spreading step of, after conveying the stacked disks manufactured in the disk stacking step to a rotating stand for spreading adhesive agent by a transfer arm, spreading the adhesive agent applied to the stacked disks on the rotating stand; and
a light ray irradiating step of, after conveying the stacked disks where the adhesive agent has been spread on the rotating stand to a light ray irradiating table by the transfer arm, curing the adhesive agent.

3. An optical disk laminating device comprising:
a lower disk supplying unit for placing a lower disk on a rotating table; an upper disk supplying unit for placing an upper disk on the rotating table, which is provided on a downstream step side of the lower disk supplying unit;
an adhesive agent applying unit for an upper disk which is provided on a downstream side of the upper disk supplying unit, for applying adhesive agent on the upper disk from the above;
a reversing unit which is provided on a downstream step side of the adhesive agent applying unit for an upper disk, for reversing the upper disk applied with the adhesive agent;
an adhesive agent applying unit for a lower disk which is provided on a downstream step side of the reversing unit, for applying adhesive agent to the lower disk from the above;
a suction unit for lifting up the lower disk, while sucking the same, and laminating the lower disk with the upper disk; and
a stacked disks transferring device which has a sucking portion which sucks and holds the upper disk when the upper disk and the lower disk are laminated, conveying the stacked disks from the rotating table to a rotating stand for spreading adhesive agent, and conveying the stacked disks where the adhesive agent has been spread on the rotating stand to a light ray irradiating table, wherein
an upper and lower disks placing jigs on which the upper disk and the lower disk can be placed with a space in a vertical direction are provided around a disk placing portion on the rotating table.

4. An optical disk laminating device comprising;
a lower disk supplying unit for placing a lower disk on a rotating table;
an upper disk supplying unit which is provided on a downstream step side of the lower disk supplying unit, for placing an upper disk on the rotating table;
an adhesive agent applying unit which is provided on a downstream step side of the upper disk supplying unit, for applying adhesive agent from the nozzle inserted between the upper disk and the lower disk on at least one of a lower face of the upper disk and an upper face of the lower disk;
a suction unit for lifting up the lower disk while sucking the same and laminating the lower disk with the upper disk; and
a stacked disks transferring device which has a suction portion for sucking and holding the upper disk when the upper disk and the lower disk are laminated to each other, conveying the stacked disks from the rotating table to a rotating stand for spreading adhesive agent, and conveying the stacked disks where the adhesive agent has been spread on the rotating stand to a light ray irradiating table, wherein
an upper and lower disks placing jigs on which the upper disk and the lower disk can be placed with a space in a vertical direction are provided around a disk placing portion. on the rotating table.

5. An optical disk laminating device according to claim 3, wherein the upper and lower disks placing jig comprises an upper disk placing portion and a lower disk placing portion, and the upper disk placing portion is movable between a position where the lower disk can be inserted up to the lower disk placing portion and a position where the lower disk is placed.
